(19) United States
(12) Patent Application Publication
(10) Pub. No.: US 2002/0010721 A1
(43) Pub. Date: Jan. 24, 2002

(54) Automated print procurement method, apparatus and system

(76) Inventors: John D. Crimmins III, Reading, MA (US); James G. Lenox, Reading, MA (US); Eric J. Dellorusso, Reading, MA (US); Francis J. Burgholzer, Reading, MA (US)

Correspondence Address: GORDON KESSLER, ESQ., FROMMER LAWRENCE & HAUG LLP, 745 Fifth Avenue, New York, NY, 10151, US

(21) Appl. No.: 09/886,315

(22) Filed: Jun. 21, 2001

Related U.S. Application Data
(60) Provisional application No. 60/214,970, filed on Jun. 29, 2000.

(51) Int. Cl. G06F 17/21

(52) U.S. Cl. 707/527

(57) ABSTRACT

A method for automatically preparing and manufacturing a printing job, comprising the steps of entering a predetermined web page, the predetermined web page being customized for use by a particular user and selecting a desired print document from among a predetermined number of print documents. Various information to be included in the print document is selected and other information is automatically inserted to the print document in accordance with an identity of the particular user. The order for the print document is completed, including proofing the print document and printing plates are automatically generated from a digital image including information from the print document. The printing job is printed and delivered to the user.

### BACKGROUND OF THE INVENTION

This invention relates generally to a method, apparatus and system for automating a printing procurement and fulfillment process, and more particularly to a method, apparatus and system allowing for a streamlined designation and acquisition of corporate identity and other personalized printing products.

The domestic commercial printing market has been estimated at about 130 billion dollars annually. Over 75,000 printers compete for this business, making it the most crowded manufacturing segment in the United States. The corporate identity (business cards, stationery, etc.) printing niche includes close to 50,000 printers competing for almost 16 billion dollars of business. While there are a few large national players, most of the business is spread among many small regional printers averaging less than 2 million in annual revenues. Most of the printers lack the funding and the expertise to independently develop technology leveraging any opportunity the Internet now offers.

The printing of corporate identity materials has a number of characteristics that make it very different from other niches within the commercial printing universe. Typically, corporations spend a significant amount of money developing a brand that they want to have represented consistently throughout their organization on all communications and products. Usually, these so called identity guidelines are very specific as to the graphics, layout, fonts, codes and paper stock to be used for a variety of items. Many of these corporate identity items usually require the addition of personalized information to the standard material included in the guidelines. Consequently, the printing of these items is usually done in short runs, 500 to 1000 pieces of each item per run. Nearly every person in an organization requires these materials and ends up spending time procuring them. The products must each be personalized for each person in the organization.

The business-to-business printing marketplace differs greatly from the small business or consumer market for corporate identity printing. While the ideal system for a small business market or a consumer market allows a user to create a corporate identity or other information from scratch, for the business to business market place, an overriding important feature is to ensure compliance with predefined company identity standards.

At this time, most companies follow a manual paper based workflow as individuals throughout the company attempt to procure basic corporate identity materials. It is not uncommon for this process to take six weeks or more from initiation to receipt of the requested materials. Error rates can run as high as 10%, a direct result of the number of people and staff usually involved in the process.

FIG. 1 depicts a typical process required for manual paper based workflow for ordering corporate identity materials. As is shown in FIG. 1, this procedure is divided generally into three distinct sessions. A first session 1000 takes place at the customer's location, a second session 2000 takes place at the printer, and a third session 3000 takes place once again at the customer site. Each of these processes will now be discussed in greater detail.

As is shown in FIG. 1, when an individual as a customer is to request corporate identity printed materials, the individual customer first request, receives and fills out request forms, and returns the forms to the purchasing person at the company responsible for ordering corporate identity products. Thereafter the purchaser places the order. This order placement is normally performed by the transmission of a particular form by mail, electronically other transmission method. Thereafter, processing leaves session 1000 at the customer, and proceeds to session 2000 at the printer.

As is shown in session 2000 of FIG. 1, a printer first receives an order from the customer and manually composes the text and graphics from the request form onto the printing material. Through this process, the printer creates a proof sheet. The printer then sends this proof sheet back to the customer. Control then returns temporarily to session 1000 in which the proof sheet is reviewed by the customer. If any alterations are necessary these alterations are indicated by the customer on the proof sheet. The customer then forwards a revised purchase order with alterations on the proof sheet back to the printer who receives the altered order. This loop continues between alterations by the customer, transmission, re-composition of the text and graphics, and retransmission of the proof sheet to the customer until the customer approves the proof sheet.

Upon final approval the customer sends the proof sheet in session 1000 to the printer in session 2000. The printer stripes the job including the image to film in which the logo and text are matched. Thereafter, as is further shown in FIG. 2, in session 2000 the printer bums the plates and prints and finishes the job. Thereafter, the printer ships the job and prepares the invoice.

Control then passes back to the customer at session 3000. After the printer ships the job, the purchaser receives the job. The purchaser then delivers the goods to the appropriate individual in the company. Simultaneously, the company receives an invoice and forwards it to the accounting department. The accounting department or other entity, approves the invoice, accounts payable processes the invoice, and the company issues a check to pay the invoice.

As is clear, this manual system of printing procurement is time consuming and labor intensive with many procedures required to be performed many times.

Therefore, a number of companies provide a printing procurement process accessible to a customer via the Internet. Companies such as ImageX and Collabria have developed technology for corporate identity commercial printing. Each of these systems offers broad catalog and user shopping cart approach. An order is built with a separate process for each item. ImageX sells generally to corporate customers, while Collabria sells their system directly to printers. Furthermore, other small players exist in the market. ImageX and Collabria are the two largest with the most advanced technologies to date. However, while these and other companies allow for shopping for printing over the Internet, they do not allow for ease of setup, design, shopping, and a complete procurement solution for corporate identity products and for printing setup in general.

Therefore, it will be beneficial to provide a method, apparatus and system that overcomes these drawbacks of the prior art.

### OBJECTS OF THE INVENTION

It is therefore an object in the invention to provide an improvement of the apparatus and system for procurement of corporate identity and other printing products.

If other objects of the invention is to provide a method, apparatus and system whereby each individual in a corporate structure can order approved corporate identity or other printing products directly online.

Still another object of the invention is to provide a method, apparatus and system whereby each individual user of a company can individually procure customized corporate identity or other printing products from an online catalog.

Another object of the invention is to provide an improved method, apparatus and system whereby one or more designated individuals for a corporation can define a corporate identity or other printing product catalog online.

Still another object of the invention is to provide an improved method, apparatus and system whereby one or more designated individuals of a company can generate a corporate identity catalog, each item including fixed portions relating to the corporate identity, and further allowing for designated entries to be made by each of a plurality of individuals to partially customize these products.

Another object of the invention is to provide a fully automated method, apparatus and system from designated and order to shipping for procurement of corporate identity products.

Still other objects and advantages of the invention will in-part be obvious and will in-part be apparent from the specification and the drawings.

### SUMMARY OF THE INVENTION

In accordance with the invention, an Internet based business to business solution is provided to automate most of the traditional commercial printing process. Users of this invention can access custom websites that represent catalogs and product listings of printed business materials that include portions thereof with corporate identities that are fixed, and also gives the ability for these individuals to customize these items while ordering online. Users can create orders by selecting items from the catalog, personalizing them, proofing them, ordering, and if authorized, paying for them all during the online session. During the online session, the system produces a digital file for each printed piece ordered. The system then delivers these digital files across the Internet or other public or private communications network to printing manufacturing facilities where they can be printed directly, bypassing the traditional striping and pre-press processes. The new process created in accordance with the invention reduces the time it takes customers to place orders, possibly to less than two minutes, and enables printers to manufacture and ship printed products usually within five days of creation of the order. Thus, customers are provided with a streamlined process for procuring needed printed materials. Printers are provided with a quicker, cheaper and more accurate way of producing these materials.

The improved process of the invention can save up to 75% of the time currently spent by customers procuring these materials. The invention also saves up to 60% of the time spent by printer personnel preparing these materials for printing. Each corporate customer sets up its catalog to its exact specifications according to corporate identity guidelines, so that accuracy and consistency between orders is insured.

The invention is designed with the interests of both corporate print customers and commercial printers in mind. The features of the invention built in to the method, apparatus and system work together to create the simplest possible workflow throughout the entire procurement business cycle. Users of the system of the invention are only required to enter information corresponding to what is necessary for what they are ordering. All information entered is captured and stored in databases so that users will not be asked for information they have already provided during a previous session. The workflow of the invention requires requisitioners to identify the items they are ordering from the catalog and then captures all information that is necessary to customize each item and to complete the order in a single short cycle. The result is a much shorter session and more efficient use of time for the requisitioner. Everything about the process of the invention, from workflow to catalog display, is focused on presenting only information the customer requires to complete the procurement transactions as quickly and as easily as possible. The invention includes automation of the custom catalog setup option. Any user wishing to design and use online custom print catalog can easily log online, design any artwork, and set up such a catalog. Thereafter, others from the company procuring printed materials are presented with certain fixed elements, and other changeable elements in each product, as defined in the catalog.

The invention accordingly comprises the several steps in relation of one or more of such step with respect to each of the others, and the apparatus and system embodying features of construction, combination of elements and arrangement of parts that are adapted to effect such steps, or as exemplified in the disclosure, and the scope of the invention will be indicated in the claims.

### BRIEF DESCRIPTION OF THE DRAWINGS

For a more complete understanding of the invention, reference is made to the following description and accompanying drawings in which:

FIG. 1 is a flow chart depicting a prior art process for ordering corporate identity printing material;

FIG. 2 is a flow chart depicting the general construction of the apparatus and system of the invention;

FIG. 3 is a flow chart depicting a more specific embodiment of the invention;

FIG. 4 depicts a field definition and data entry component of the invention; and

FIGS. 5-16 depicts screen shots in accordance with a preferred embodiment of the invention that are indicative of the types of screens a user will encounter upon use of the invention.

### DETAILED DESCRIPTION OF THE PREFERRED EMBODIMENTS

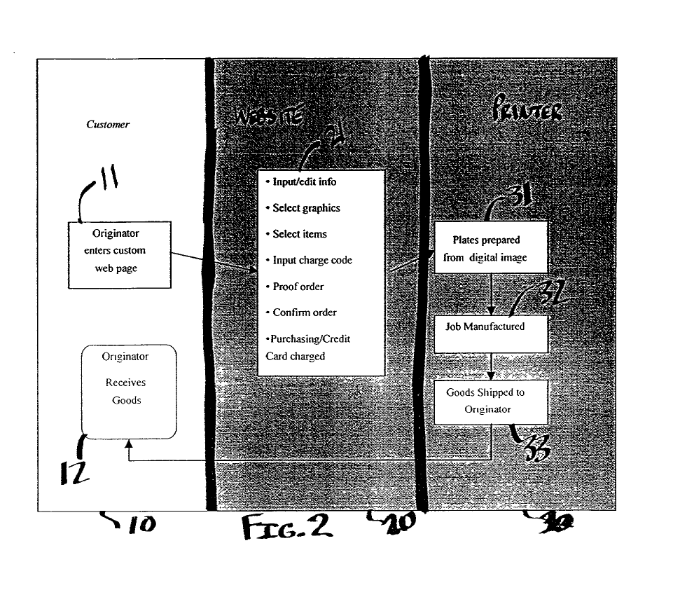

Referring first to FIG. 2, a general structure of the method, apparatus and system constructed in accordance with the invention is shown. As is shown in FIG. 2, the invention consists of three modules, each enabling substantial process improvements over the prior art. Each module is designed to improve a particular business process associated with procurement, manufacturing and management of corporate identity materials.

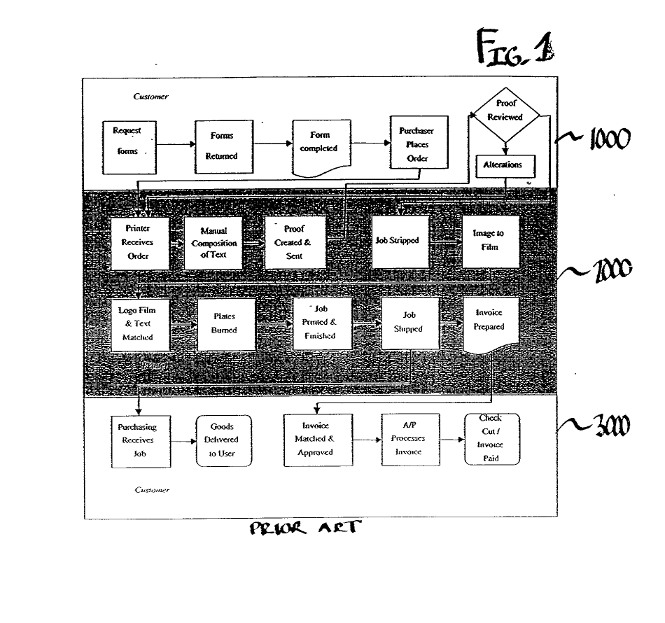

As is shown, a module 10 resides at the customer side. Module 10 further includes an operation block 11, in which an originator of an order enters a custom web page. Control then passes to a module 20 at web site 21. At web site 21, the originating customer entering custom web page at 11 inputs and edits various information, selects graphics and various other items, and inputs various charge codes for apportioning payment. Upon generation of the order based upon the customer's requests, the user is asked to proof and confirm the order. Upon confirmation, the purchasing order is generated, and a credit card charged, a bill is sent out or other billing processing is performed. After the order has been confirmed, control passes to a module 30 where the printer prepares plates from a digital image at step 31, the printer manufactures the print job at step 32, and at step 33 the printer ships the finished goods back to the originator. Control then returns to module 10 where at step 12, the originator receives the finished goods. This method of the invention for procurement of printing materials is far simpler than that depicted in the prior art process of FIG. 1.

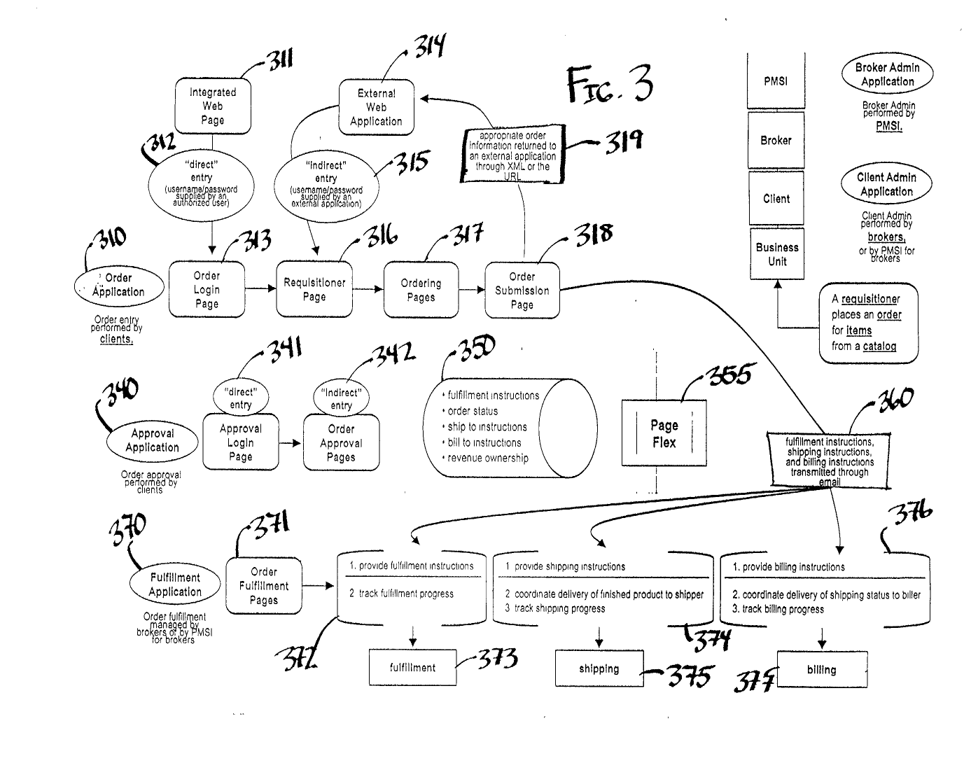

Referring next to FIG. 3, a flowchart depicting the function of the invention for ordering a particular corporate identity customized print material will be described. The process is essentially divided up into three general areas, an order application 310, an approval application 340, and a fulfillment application 370.

As is shown for order application 310, a customer first enters the system. Access is provided to the invention by one of two preferred methods, in accordance with an exemplary embodiment. Either an integrated web page 311, or an external web application 314 may be provided. When using the integrated web page 311, such a web page is provided specifically for a user based upon his or her company affiliation.

After visiting the integrated web page at step 311, at step 312 a user directly enters an authorized user name and password. Control then passes to step 313, where the user is logged in for the processing of the procurement of an order.

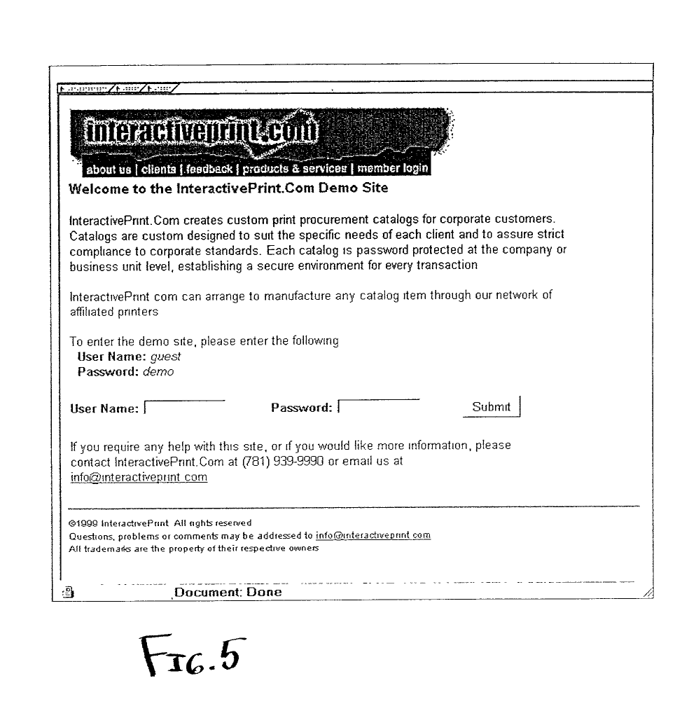

At step 313, the user is presented with a screen such as that shown in FIG. 5, by way of example. Through entry of the proper user name and password in step 312, this combination determines which data base and web pages the user is provided access to, and may include references to a particular company and a particular business unit within the company. The accessed data base and web pages include a listing of custom products for the particular company in a catalogue format, predetermined prices and, a library of custom graphics images including catalogue items and company logo to display on the web pages that are accessible to the particular user.

If an external web application 314 is used as the entry method, a separate web site is provided for a user. Upon entry of information at the external web application, indirect entry, including user name and password being supplied by external web application 314 to the invention is provided at step 315. Thereafter, control passes to requisition of page 316 as during the use of integrated web page 311.

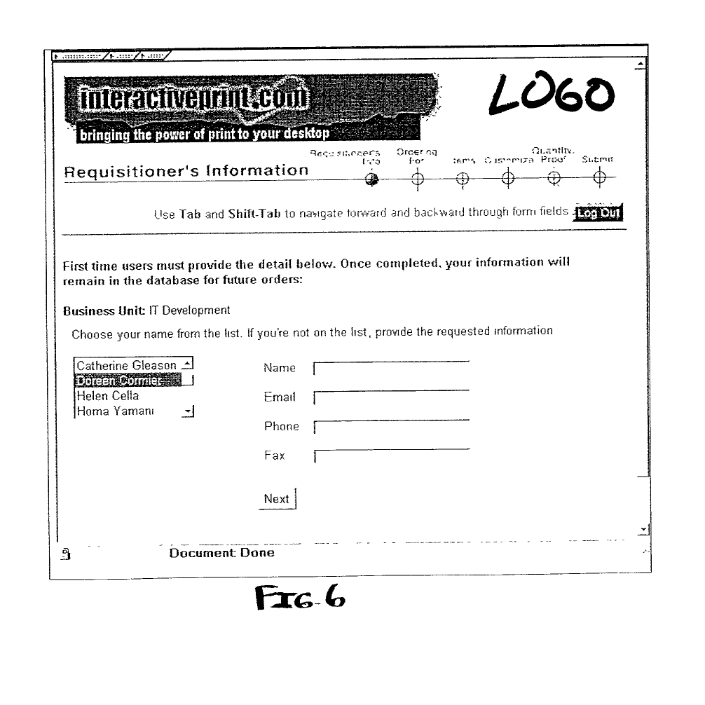

Upon arriving at requisitioner page 316 via either entry method, the user is presented with a screen such as that shown in FIG. 6, by way of example. As is shown in FIG. 6, a corporate Logo or other designating information determined according to the particular user is displayed. A user is requested to input detailed information about the person who is ordering the corporate identity printed material. All input information is captured in a supporting data base. A list of previous requisitioners for the particular corporate entity is presented in a scroll box, and selection of a name from the scroll box pulls up appropriate recorded information for that individual in the appropriate locations on the screen. Information can be edited from the screen, and any updated information is captured as part of the order. Additionally, new requisitioners may be entered into the system by entering the appropriate requested information on the screen.

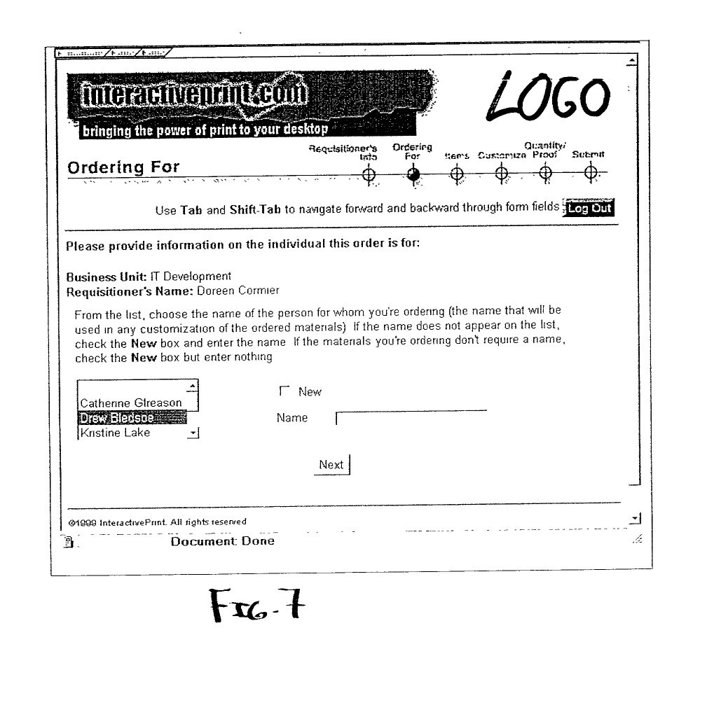

After all requisitioner information has been entered, control passes to step 317 and ordering pages are provided. The ordering pages at step 317 will now be described, making reference to FIGS. 7-16.

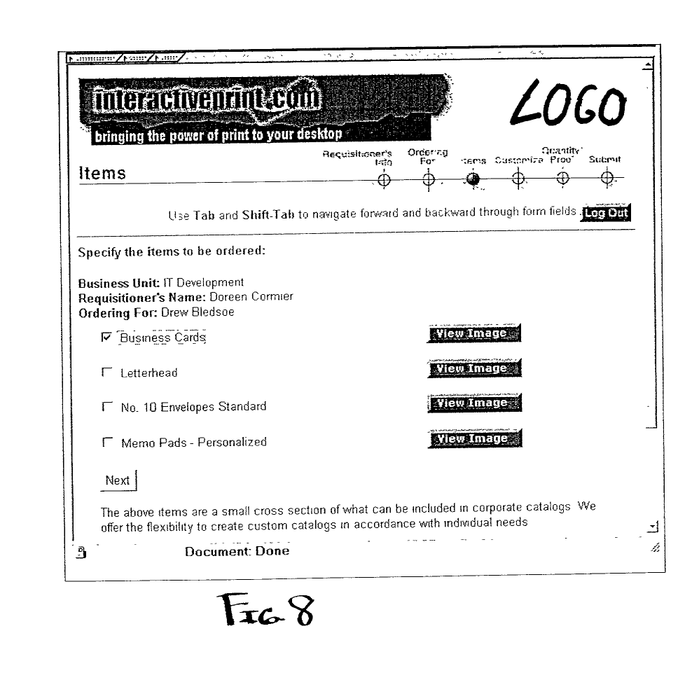

As is first shown in FIG. 7, the name of a person for whom customized corporate identity printing is being ordered is indicated and captured. Thus, if the person has previously had print materials ordered for him or her, the name is recalled from the data base for editing after selection of the name from the pull-down box. If the print material for the person is being ordered for the first time, an indication is placed in the “new” box and entry of a new name creates a new record in the data base. Upon entry of the appropriate information, user is passed to a screen such as that shown in FIG. 8.

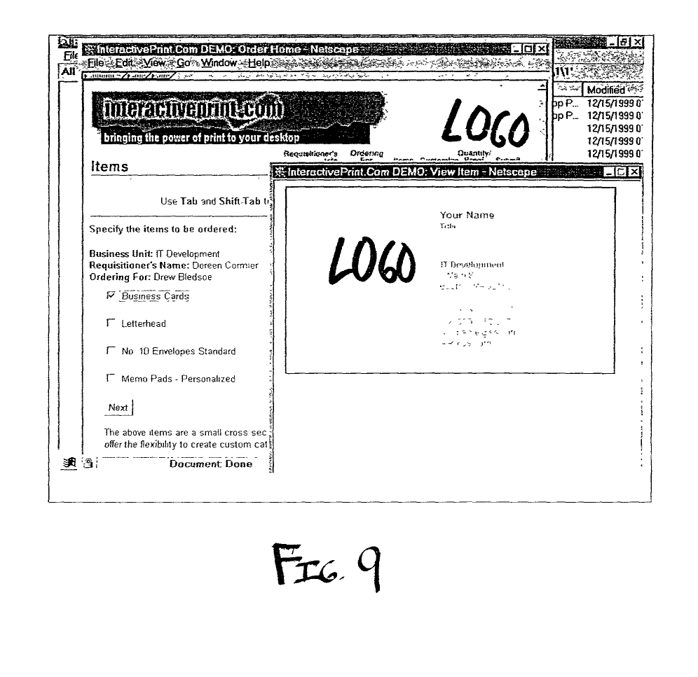

As is shown in FIG. 8, the product offerings from the custom catalogue for the company and business unit to the particular person for whom the print material are to be ordered, are presented. The requisitioner then selects the items to be ordered. A requistioner can view an image of each of the possible selections. Upon a request to view an image for business cards, for example, the user is shown a screen such as that depicted in FIG. 9. As is shown in FIG. 9, a picture of the catalogue item selected is presented so the user can be sure to select the correct item. A second small browser window is launched for this product. As is shown, default entries for various fields, such as name, title, telephone, fax, e-mail and the like are depicted. Referring back to FIG. 8, once a desired product or products are selected, the user clicks on the next button to move to the next phase of ordering.

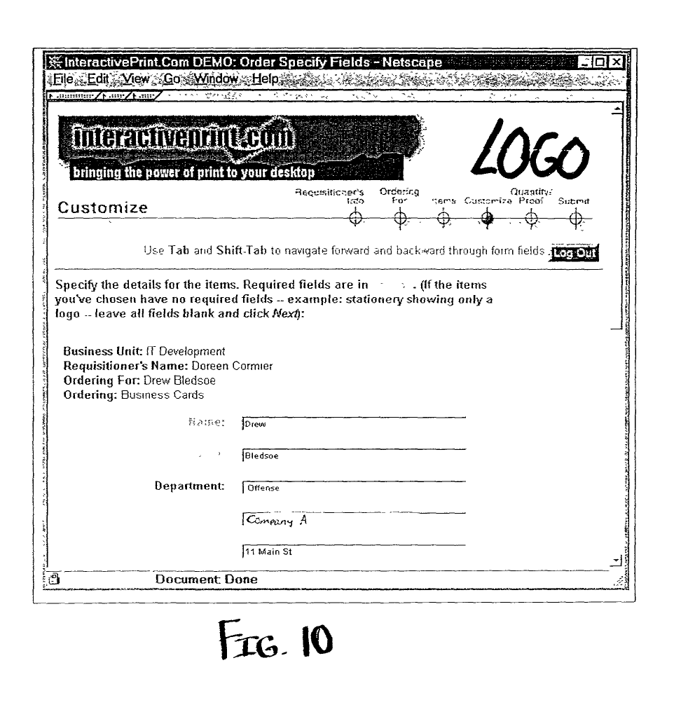

The clicking of the next button in FIG. 8 brings a user to a customizing screen as shown in FIG. 10. As is shown in the customizing screen, if a person for which printing materials are to be ordered has had these materials ordered for him or her previously, the information previously used for this person is presented on the screen. Fields may be edited as desired. Noticeably, information is only requested as is necessary for the desired products selected in FIG. 8. Thus, while business cards may require the most information, if only letterhead, memo pads or envelopes were requested, elements such as department, and other material (not shown on this screen), such as phone number, fax number and the like may not be requested from the user. While not shown in FIG. 10, a scroll-down bar on the right side of the screen indicates that additional information is requested therebelow. After all information has been properly entered, the user clicks on a selection button (not shown) to confirm the information, and move to the next screen.

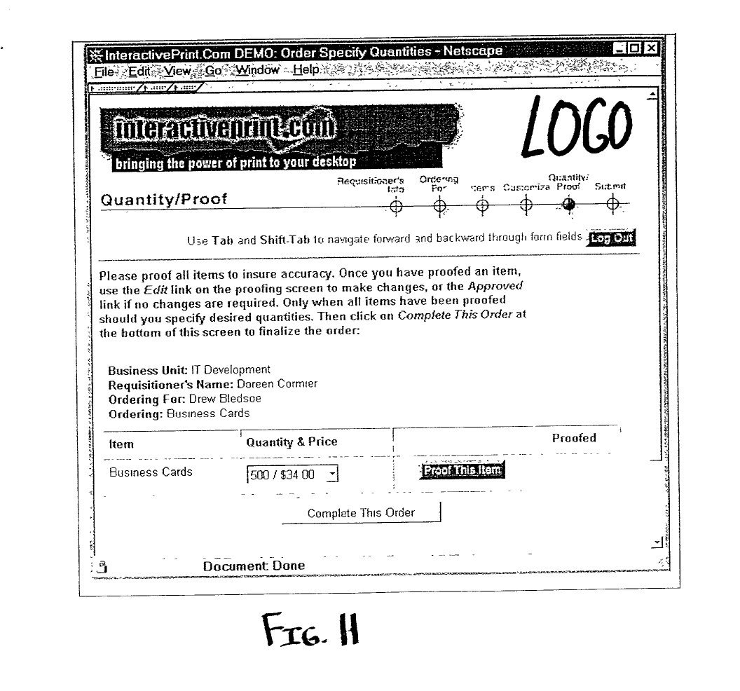

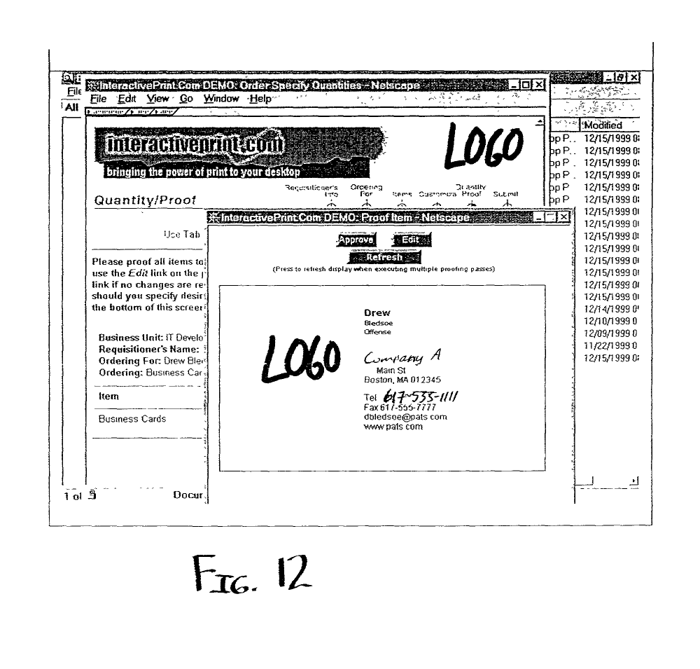

The next screen shown to a user is the quantity/proofing page depicted in FIG. 11. At this page, a number of predetermined price/quantity options are presented for selection in a drop-down menu. The user is required to proof each item ordered on line before ordering. Thus, a user must select the “Proof This Item” box which launches a separate window showing an image of the actual item ordered including the customized text and graphics. Such a proof is shown in FIG. 12.

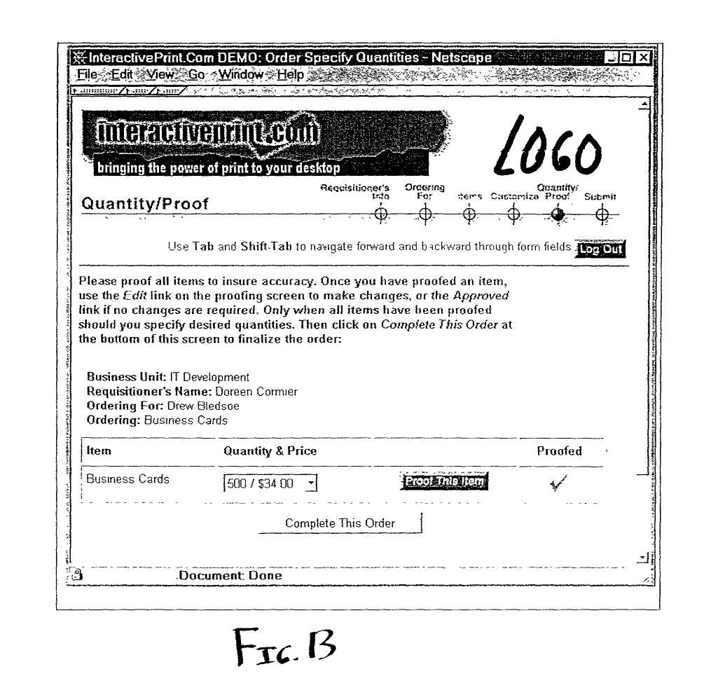

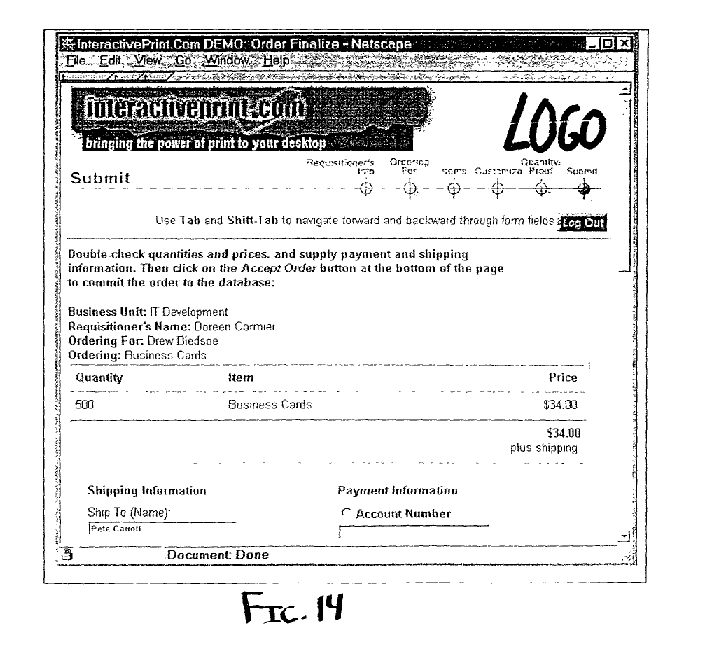

As is shown in FIG. 12, all material, including behind the scenes data from the order, corporate graphics and style/layout guidelines for each item are used to build the graphics file. The layout for each piece is determined by the customer so that the set up process as is consistent with corporate identity guidelines. The actual viewed file by the user is the file sent to the printer, so that no re-typesetting or the like are required, therefore, reducing the likelihood of a printing error. Upon viewing of the image, the user either can approve or edit the image. Approval is required to allow processing of the order. Upon approval, control passes back to FIG. 11, and an indication is made that the item has been proofed. Once a user has proofed each item, the user is shown an updated screen such as that shown in FIG. 13 indicating that each item has been proofed. However, if a user should request to edit the product, the user is brought back to the customizing screen shown in FIG. 10, and information may be adjusted. Upon selection of the “Complete This Order” button in FIG. 13 after proofing each of the items, control passes to a screen such as that shown in FIG. 14.

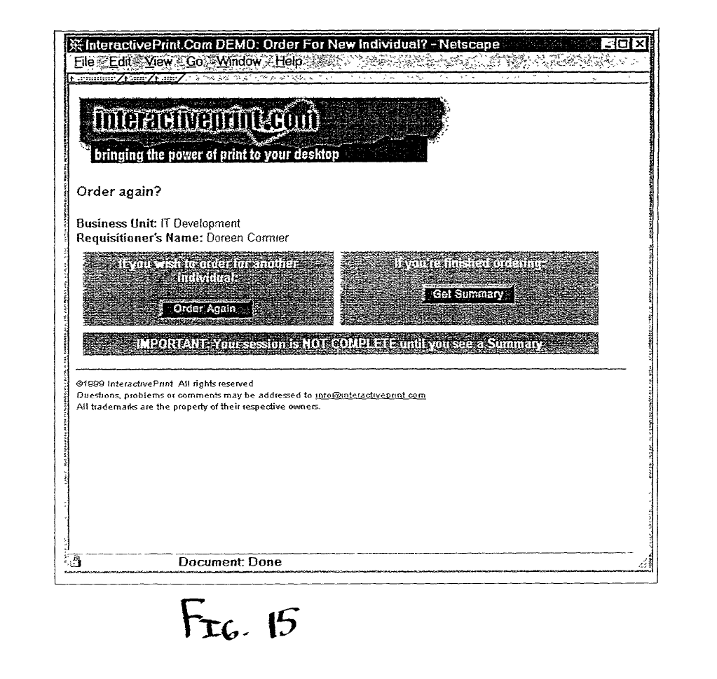

Upon reaching the screen shown in FIG. 14, an order summary is presented for the user's review. Various shipping fields are presented for completion or editing. Shipping information is captured in the data base file and is associated with the ordering name in the data base. Thus, if the person has already been ordered for, saved, previously used shipping information is presented. Predetermined customer payment options as defined by the company are presented to the user. Relevant data is input as required, and a user may purchase via a credit card/procurement card, account code, purchase order number or other method. If a credit card number is used, the credit card is validated on-line through cybercash or other appropriate vendor, although the credit card is not actually charged until goods are shipped. As shown in FIG. 14, the scroll-down bar on the right side of the screen indicates that additional information (not shown) is requested below. Upon completion of the shipping and order payment information, an order is finalized, and a user is passed to a screen such as that shown in FIG. 15.

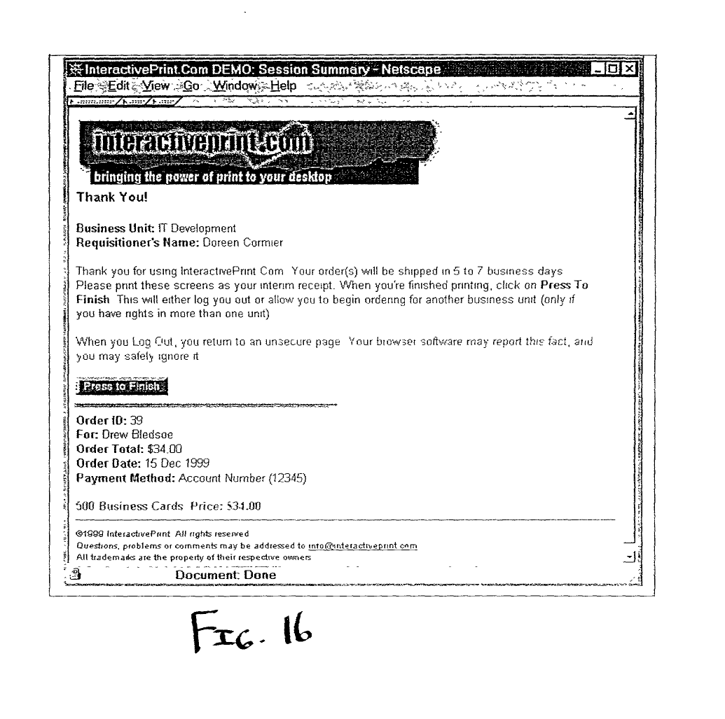

Thus, after completion of the order, as is shown in FIG. 15, while still logged onto the system, the requisitioner is given the option of ordering print information for another person before leaving the system or completing the session. Thus, the requisitioner has the option of ordering again, which brings the user back to the ordering screen shown in FIG. 7 to begin a new order. Alternatively, a user may get a summary, therefore, bringing the user to the final screen in the process, shown in FIG. 16.

As is shown in FIG. 16, a final order summary is provided before exiting the system. All elements of the order are presented to the user. This summary can be printed out or saved electronically. Upon completion, the user clicks on the “Press To Finish” button, the user is logged out of the secure system and returned to the home page of the invention.

Reaching of page 16 and completion of the order completes processing of information in ordering pages 317. The order is then electronically submitted to the system at a submission page 318 of FIG. 3. The information is in turn submitted to fulfillment module 350. Fulfillment module 350 generates fulfillment instructions, maintains a record of order status, records the ship to and bill to instructions and determines cost of the order, and the appropriate party to be paid.

As is next shown in FIG. 3, if an order approval is required, order approval application 340 is utilized. As is shown at approval application 340, the same or another user may re-enter the system via direct entry approval log-in page 341 and thereafter be forwarded to order approval pages 342, via indirect entry. The user may also enter and immediately be forwarded into order approval pages 342. Of these pages, the user may independently approve an order placed for submission at order submission page 318. This feature may be preferable when a third person, perhaps purchasing manager or the like, must approve all orders placed by other members in the company.

Referring once again to fulfillment module 350, a Page Flex program 355, or the like, is employed for the creation of digital print files. Page Flex is a third party application that produces the digital print files. On-line proofing is available, and is built around this Page Flex program. This Page Flex product enables the easy creation of fixed layout digital print files using variable text content. This new technology provides the invention with a functional advantage over prior methods. Set up of catalogue items is easier (as will be described below). Furthermore, digital output in any format required by the many different digital printing devices in the marketplace can be provided. Finally, online viewing and approval of the actual file to be printed helps to reduce error. The Page Flex program can support the creation of very large print files, and allows easy sharing of information with other e-commerce suppliers.

Therefore, between fulfillment module 350 and Page Flex program 355, submitted orders are filled, shipped and billed, and revenue is properly designated. While fulfillment is taking place, control is also simultaneously forwarded to step 360, where fulfillment instructions, shipping instructions and billing instructions are transmitted via e-mail to the proper channels.

After products have been entered into fulfillment module 350, control passes to fulfillment application 370 which is managed by a third party or printer. Thus, control passes to order fulfillment pages 371. The steps provided therein include providing fulfillment instructions and tracking fulfillment progress at step 372, the result of this step being fulfillment of the order at step 373. After fulfillment, shipping instructions are provided, delivery of finished product to the shipper is coordinated and shipping progress is tracked at step 374, resulting in the proper shipping of product 375. Simultaneously, billing instructions are provided, the delivery of the shipping status is coordinated to the biller and the billing progress is tracked at step 376, resulting in proper billing at step 377.

In this manner, it is possible to provide accurate and easy ordering of corporate identity materials.

As is noted above, when designing a corporate identity product, certain aspects of each product remain fixed in order to maintain continuity in the corporate identity material, certain material may include any fields that can hold, any information, and certain other fields may be limited to particular choices of information. While in the prior art it is necessary for a customer to contact the provider of the print interface web site directly to set up such a “catalogue” of information, in accordance with the invention, it is possible to provide the designing of this particular material on line.

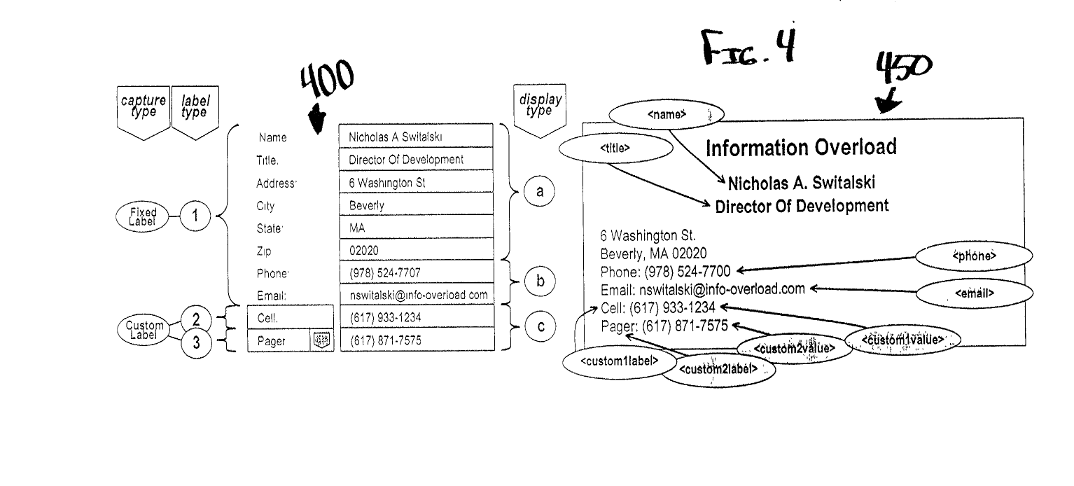

Referring next to FIG. 4, an example of setting up a template for a catalog business card entry is shown. As is shown in FIG. 4, a setup cell 400 is provided, alongside a business card design view 450 incorporating the data from setup fields 400. During setup, a designer can designate one or three types of fields. These three types of fields include a fixed label field, a custom label text field and a custom label list field. Fixed label fields are shown at element 1 at portion 400 of FIG. 4. At setup time, the administrator selects one of the predefined fields whose capture type is fixed label and associates it with the current item catalogue. Thus, a predetermined number of fixed labels are available for a designer to select. At order time, this fixed field will provide the user with a labeled text box for input of appropriate information.

A custom label text field is shown at portion 2. At setup time, the designer selects one of the predefined fields whose capture type is custom label and associates with it with the current item catalogue. She/he then sets the field label type to text. At order time, this will provide the user with a pair of text boxes, one for input of the text that will be used to label the information on the final printed piece and one for input of the appropriate information. Thus, as is shown at portion 2, a user has entered the label “Cell:” and a cell phone number as the information.

Finally, a third custom label list field may be defined. At setup time, the administrator selects one of the predefined fields whose capture type is custom label and associates it with the current item catalogue. She/he then sets the fields label type to list. The administrator then defines a list of valid labels that can be used with the selected field. At order time, this will provide the user with a list box of valid labels from which to select the text that will be used to label the information on the final printed piece and a text box for input of the appropriate information. Thus, as is shown at portion 400, a pull-down list is provided, and a user has selected pager and entered a pager number associated therewith. Any number of other predefined selections may be provided in the pull-down list. Therefore, in accordance with this design critique, a designer may select one of three different types of fields, by way of example. More types of fields may also be provided. The selection of these fields defines the information to be entered by a user.

Referring next to section 450 of FIG. 4, the information taken from section 400 as entered by a user is placed on a business card. Thus, the name and title from the name and title fields are provided, as well as the phone, e-mail, custom label 1 along with custom value 2, and custom label 2 along with custom value 2. Therefore, in this manner, it is possible for a designer to set up a template for users to use to insure that all corporate identity product conforms to a predetermined standard. While no logos or the like are depicted in FIG. 4, other than the name of the name of the company “Information Overload”, any other graphics or the like may also be incorporated by a designer.

In accordance with the invention, a complete solution is provided for procurement through manufacturing of corporate identity print products. Custom catalogues may be designed by each customer for each customer accessible through secure private websites where corporate requisitioners build on-line orders. As the orders are completed, digital print files are generated and directed to printers for printing. Printers who are to perform the printing are part of a network of affiliated printers. To become an affiliated printer, printers must have the ability to accept and process digital print output, and must demonstrate a consistent sustained ability to produce high quality, timely materials.

Many corporate customers have well-established relationships with printers, usually in their local areas. Some of these corporate customers may be reluctant to direct their printing elsewhere, but would like the procurement advantages of the invention. In this case, in accordance with the invention the use of the invention to is offered to these corporate customers, and print orders are directed to their preferred printer. In addition to providing a complete procurement and manufacturing system, it is also possible to provide only the procurement system, returning digital print files to a particular company. The company is then able to transmit these digital print files to any printer, or print in-house as desired.

It will thus be seen that the objects set forth above, among those made apparent from the preceding description, are efficiently attained and, because certain changes may be made in carrying out the above method and the constructions set forth, without departing from the spirit and scope of the invention, it is intended that all matter contained in the above description and shown in the accompanying drawings shall be interpreted as illustrative and not in a limiting sense.

It is also to be understood that the following claims are intended to cover all the generic and specific features of the invention herein described, and all statements of the scope of the invention which, as a matter of language, might be said to fall therebetween.

What is claimed is:

1. A method for automatically preparing and manufacturing a printing job, comprising the steps of:
entering a predetermined web page, said predetermined web page being customized for use by a particular user;
selecting a desired print document from among a predetermined number of print documents;
selecting various information to be included in said print document;
automatically inserting other information to said print document in accordance with an identity of said particular user;
completing an order for said print document including proofing said print document;
automatically generating printing plates from a digital image including information from said print document; and
printing and delivering said printing job to said user.
